(19) United States
(12) Patent Application Publication
(10) Pub. No.: US 2026/0170845 A1
(43) Pub. Date: Jun. 18, 2026

(54) FLOW GUIDED ADAPTIVE OBJECT DETECTION

(71) Applicant: QUALCOMM Incorporated, San Diego, CA (US)

(72) Inventors: Rahul AHUJA, San Diego, CA (US); Venkatraman NARAYANAN, Northville, MI (US); Varun RAVI KUMAR, San Diego, CA (US); Senthil Kumar YOGAMANI, San Diego, CA (US)

(21) Appl. No.: 18/980,806

(22) Filed: Dec. 13, 2024

(51) Int. Cl. G06V 20/58; B60W 30/09; G06T 7/246; G06T 7/73; G06V 10/80; G06V 10/82

(52) U.S. Cl. CPC G06V 20/58; B60W 30/09; G06T 7/246; G06T 7/73; G06V 10/806; G06V 10/82

(57) ABSTRACT

Certain aspects of the present disclosure provide techniques for adaptive object detection. An example method includes obtaining a first feature concatenation corresponding to a scene for a first timeframe and a second feature concatenation corresponding to the scene for a second timeframe; generating a scene flow for features between the first feature concatenation and the second feature concatenation; generating one or more object proposals for one or more groups of features in each of the first feature concatenation and the second feature concatenation; fusing the scene flow and the one or more object proposals into a representation of the scene; identifying, with a decoder fed the representation of the scene, objects, wherein the objects comprise at least one object from the one or more object proposals and one or more additional objects; and generating, within a bird's eye representation, a respective bounding box for each of the objects.

### INTRODUCTION

### Field of the Disclosure

Aspects of the present disclosure relate to adaptive object detection techniques.

### DESCRIPTION OF RELATED ART

Sensors are useful in apparatuses, such as autonomous vehicles, robotic systems, and the like. Sensors enable perception of an environment, which may be useful for localization for path planning, decision making, object detection, object identification, and numerous other operations. Numerous sensors, such as vision sensors, radar sensors, LiDAR systems, ultrasonic sensors, and the like can be utilized to sense the environment around an apparatus. Information sensed by the sensors can support autonomous systems, such as autonomous driving, collision avoidance, or the like.

There is a need for techniques that continue to improve the quality and ability to obtain information from sensors to support the performance of autonomous systems.

### SUMMARY

One aspect provides a method for adaptive object detection by an apparatus. The method includes obtaining a first feature concatenation corresponding to a scene for a first timeframe and a second feature concatenation corresponding to the scene for a second timeframe; generating, with a transformer-based feature flow encoder, a scene flow for one or more features between the first feature concatenation and the second feature concatenation; generating, with an object encoder fed the first feature concatenation and the second feature concatenation, one or more object proposals for one or more groups of features in each of the first feature concatenation and the second feature concatenation; fusing, with an encoder of an encoder-decoder transformer, the scene flow and the one or more object proposals into a representation of the scene; identifying, with a decoder of the encoder-decoder transformer fed the representation of the scene, a plurality of objects, wherein the plurality of objects comprises at least one object from the one or more object proposals and one or more additional objects; and generating, within a bird's eye representation of the scene, a respective bounding box for each of the plurality of objects.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an illustrative environment of a road scene.

FIG. 2 depicts an illustrative sensor and computing system equipped apparatus, such as a vehicle.

FIG. 3 depicts an illustrative block diagram of an architecture for implementing adaptive object detection techniques.

FIG. 4 depicts aspects of an example method.

FIG. 5 depicts aspects of an example apparatus for adaptive object detection techniques.

### DETAILED DESCRIPTION

Aspects of the present disclosure provide apparatuses, methods, processing systems, and computer-readable mediums related to adaptive object detection techniques. More specifically, techniques described herein improve object detection through the integration of scene flow techniques with object detection within a unified pipeline.

Object detection processes are used for autonomous applications, such as autonomous vehicle control and collision avoidance. Moving objects pose complex behavior patterns and those patterns can be helpful for the performance of autonomous applications, for example. Additionally, moving objects are not limited to two dimensional motion. Three-dimensional motion increases the complexity of object detection, tracking, and identification processes. That is, not only objects do change position, but an object's behavior can be erratic or unpredictable.

Some object detection and tracking processes rely on detecting an object and bounding the object so that it may be tracked from frame to frame over time. These object detection models are sometimes trained on specific datasets that define a limited set of object categories, referred to as a closed dataset. These closed datasets create limitations to the performance of object detection models. For example, the models struggle to detect and track objects that are not part of the training data. In dynamic environments, such as autonomous driving scenarios, it is inevitable that new, unseen objects are encountered.

Object detection processes are considered to be an alternative to scene flow estimation. Scene flow estimation allows autonomous systems to reason about the non-rigid motion of independent objects without requiring object detection and identification. Current systems may implement scene flow estimation for collision avoidance based on 3D occupancy and scene flow from point cloud data (e.g., a collection of data points in three-dimensional space that represent a three-dimensional object or shape) generated by sensors, such as LiDAR and/or RADAR. Scene flow estimation methods traditionally estimate the motion of objects by establishing point-to-point correspondences between successive frames. However, when scene flow estimation methods are based on unreliable point-to-point correspondences, such as those that can arise from crowded or occluded scenarios, the system may fail to accurately detect the presence and movement of objects. Failing to detect and track unknown or dynamic objects accurately increases the risk of collisions.

Further issues can arise when false movement cues from the scene flow pipeline trigger an autonomous vehicle to make unnecessary maneuvers. Unnecessary maneuvers can disrupt traffic flow and cause delays, particularly in congested environments. This can negatively impact transportation efficiency and user experience.

Aspects of the adaptive object detection techniques described herein provide technical solutions to at least the aforementioned issues that object detection processes and scene flow estimation methods face independently. Adaptive object detection techniques described herein provide a unified pipeline that integrates scene flow estimation methods (which involve motion analysis) with object detection processes. The integration allows the system to capture both the spatial and dynamic characteristics of objects, even when the object detection models are unable to detect and track objects that are not part of the training data.

In certain aspects, the unified pipeline integrates scene flow estimation methods with object detection processes to create a rich, multi-dimensional feature set that enhances the system's ability to detect both known and unknown dynamic objects. The enhancement of the system's ability to detect both known and unknown dynamic objects can provide additional downstream benefits to the functionality of autonomous systems such as the autonomous control of a vehicle, collision avoidance, and the like.

Some technical solutions that are described in more detail herein include fusing LiDAR point clouds, camera images, and/or scene flow data to detect both known and unknown dynamic objects. The solution may include an iterative refinement process that continuously adjusts 3D bounding boxes based on updated motion data. The process can improve tracking accuracy and reduce the likelihood of false positives that can result in negative outcomes such as missed obstacles or unnecessary maneuvers.

The incorporation of scene flow estimation processes enable the system to identify objects based on their movement patterns, making the adaptive object detection techniques particularly effective at detecting new or unexpected objects that were not part of the initial training data used for training object detection models.

As described in more detail herein, the method integrates scene flow estimation methods with 3D object detection in a unified pipeline, which can allow for a more comprehensive analysis of both spatial and dynamic features of objects as compared to application of 3D object detection processes without scene flow estimation methods.

In certain aspects, a transformer-based bird's eye view (BEV) FeatureFlow Encoder may be used to encode the camera-LiDAR fused BEV features from two consecutive timeframes, thereby incorporating vehicle pose data that can be used to extract motion features from the BEV feature space. In parallel with encoding the features, a BEV Object Encoder may generate initial object proposals from the fused BEV features, which can then be used by the Object Flow Refiner to enhance feature-to-feature correspondence of the motion features across the two timeframes. A FlowFusion Object Decoder may then combine the aligned motion features and initial object proposals to accurately identify all known and unknown dynamic and static objects in the scene.

These aspects will now described in more detail with reference to the figures.

### Perception of an Environment

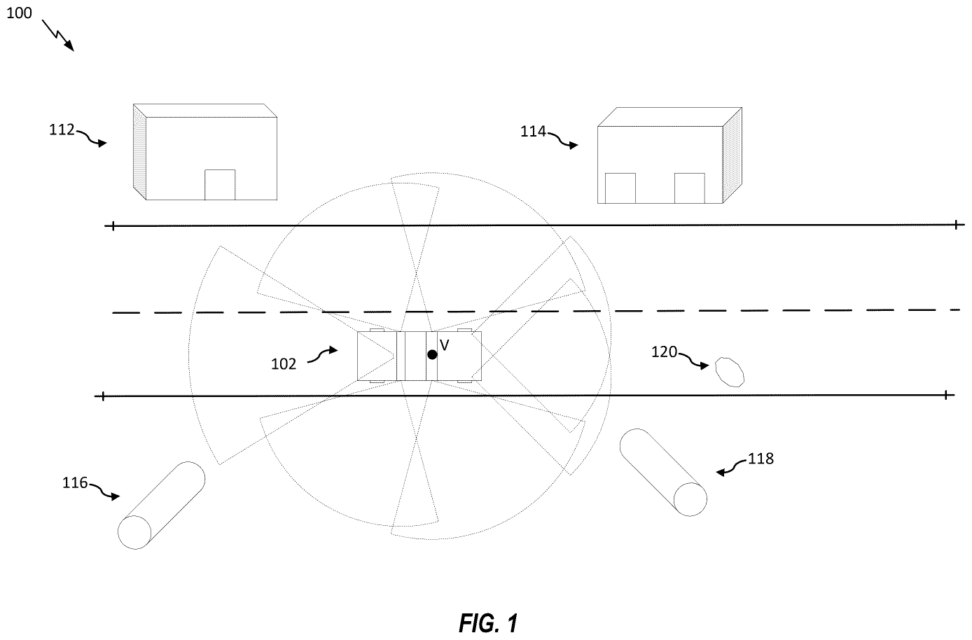

FIG. 1 depicts an illustrative environment 100 of a road scene. The road scene includes a vehicle 102 equipped with a plurality of sensors, optionally having different modalities, that are fused together following techniques described herein to generate a BEV perception of the environment. The environment may also be referred to as a scene herein. In certain aspects (not shown), the vehicle 102 may be equipped with one or more of the same type of sensor and different projections from the same one or more sensors may be fused together to generate a BEV perception of the environment. The BEV perception, which may be single-modal or multi-modal, of the environment include encoded features corresponding to features in the environment such as structures 112, 114, signs or poles 116, 118, potholes 120, and/or other features not specifically depicted in FIG. 1. Features in the environment may be physical objects or component of objects such as corners, edges, or other structures or shapes that may be invariant to rotation, translation, and illumination. The encoding of those features, which is referred to as encoded features, refers to or is the numerical representation of the feature. The plurality of sensors may each have a corresponding field of view illustratively depicted by the dashed lined fields.

Certain aspects described herein may not only utilize the view point of the sensor with reference to the sensor's field of view to search for features, but may also adjust the azimuth perspective angle of the sensor data to extract additional and richer feature information about the environment. For example, the nominal viewpoint of a camera defines its field of view. However, the image data captured by the camera can be viewed from different azimuth perspective angles and/or different angles of elevation, which are different from the nominal viewpoint of the camera in order to obtain different perspectives and potentially information about features, for example, contributing to small objects or occluded space. Certain aspects described herein provide techniques for combining multi-azimuth viewpoints and/or elevation viewpoints of the sensor data to generate more feature rich and dense BEV planes corresponding to environments of the vehicle 102.

It should be understood that while the illustrative example discussed herein include a vehicle 102 traversing a road environment, the techniques described herein may be implemented on various apparatuses such as a robot operating in a facility or other environment. Additionally, in certain aspects, the techniques described herein may be implemented on one or more various apparatuses separate from apparatus configured with sensors to collect perception sensor data of the environment. For example, the vehicle 102 may be a terrestrial vehicle such as an automobile, a truck, a motorcycle, a bicycle, a robotic device, or the like; an amphibious vehicle, such as a boat, a sailboat, a ship, a submarine, an unmanned amphibious vehicle, or the like; or an aerial vehicle such as a helicopter, a quadcopter, an unmanned aerial vehicle or the like.

Given the road scene depicted in FIG. 1, specific aspects will be described herein.

### Sensor and Computing System Equipped Apparatus

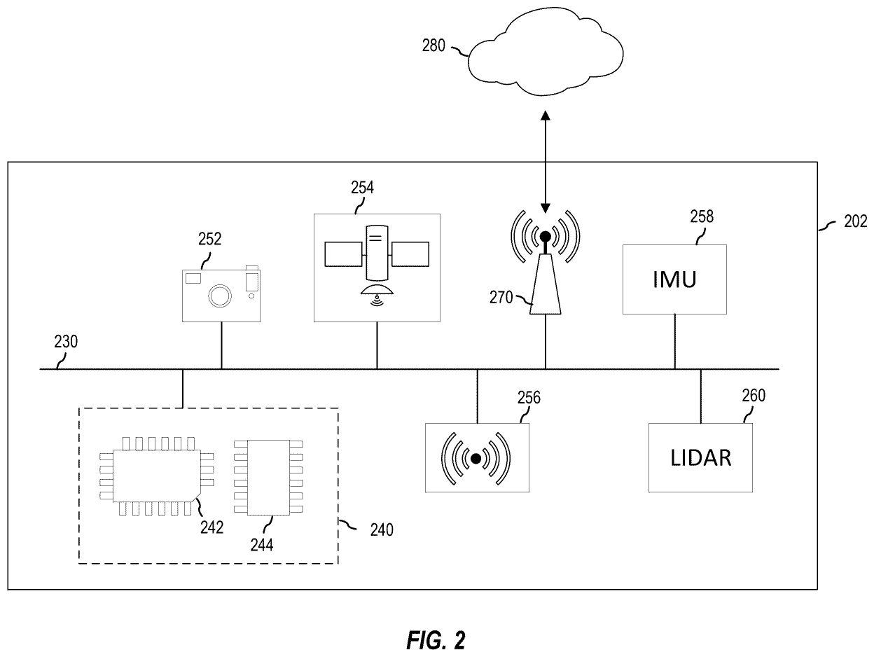

FIG. 2 depicts an illustrative sensor and computing system equipped apparatus, such as an autonomous vehicle (AV) corresponding to aspects described herein. The apparatus 202 may be an example of the vehicle 102 depicted in FIG. 1 or other apparatus such as a robot. The apparatus 202 depicted in FIG. 2 is depicted by way of an example schematic of a vehicle including sensor resources and a computing device. Not every vehicle is required to be equipped with the same set of sensor resources, nor is every vehicle required to be configured with the same set of systems for perceiving attributes of an environment. FIG. 2 only provides one example configuration of sensor resources and systems equipped within a vehicle.

In particular, FIG. 2 provides an example schematic of apparatus 202 including a variety of sensor resources, which may be utilized by the apparatus 202 to perceive and collect sensor data about the environment. For example, the apparatus 202 may include a computing device 240 comprising one or more processors 242 and a non-transitory computer readable memory 244 (also referred to herein as one or more memories), one or more cameras 252, a Global Positioning System (GPS) unit 254, a radar system 256, an IMU 258, a light detection and ranging (LiDAR) system 260, and network interface hardware 270. The aforementioned components of the apparatus are merely examples as some apparatuses may have more or less components and/or different sensors for perceiving the environment. These and other components of the apparatus 202 may be communicatively connected to each other via a communication path 230. It should be noted that non-transitory computer readable memory 244 may include volatile and/or non-volatile memory or storage.

The communication path 230 may be formed from any medium that is capable of transmitting a signal such as, for example, conductive wires, conductive traces, optical waveguides, or the like. The communication path 230 may also refer to the expanse in which electromagnetic radiation and their corresponding electromagnetic waves traverse. Moreover, the communication path 230 may be formed from a combination of mediums capable of transmitting signals. In some aspects, the communication path 230 comprises a combination of conductive traces, conductive wires, connectors, and buses that cooperate to permit the transmission of electrical data signals to components such as processors, memories, sensors, input devices, output devices, and communication devices. Accordingly, the communication path 230 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 240 may be any device or combination of components comprising one or more processors 242 and non-transitory computer readable memory, referred to herein as one or more memories 244. The one or more processors 242 may be any device capable of executing the processor-executable instructions stored in the one or more memories 244. Accordingly, the one or more processors 242 may be an electric controller, an integrated circuit, a microchip, a computer, or any other computing device. The one or more processors 242 are communicatively coupled to the other components of the apparatus 202 by the communication path 230. Accordingly, the communication path 230 may communicatively couple any number of processors 242 with one another, and allow the components coupled to the communication path 230 to operate in a distributed computing environment. Specifically, each of the components may operate as a node that may send and/or receive data.

The one or more memories 244 may comprise random access memory (RAM), read-only memory (ROM), flash memories, hard drives, or any non-transitory memory device capable of storing processor-executable instructions such that the processor-executable instructions can be accessed and executed by the one or more processors 242. The machine-readable instruction set may comprise logic or algorithm(s) written in any programming language of any generation (e.g., 1GL, 2GL, 3GL, 4GL, or 5GL) such as, for example, machine language that may be directly executed by the one or more processors 242, or assembly language, object-oriented programming (OOP), scripting languages, microcode, etc., that may be compiled or assembled into processor-executable instructions and stored in the one or more memories 244. Alternatively, the processor-executable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. The one or more processors 242 and the one or more memories 244 may be collectively referred to herein as a processing system. A processing system may additionally include one or more other components of FIG. 2.

The apparatus 202 may further include one or more cameras 252. The one or more cameras 252 may be any device having an array of sensing devices (e.g., a CCD array or active pixel sensors) capable of detecting radiation in an ultraviolet wavelength band, a visible light wavelength band, or an infrared wavelength band. The one or more cameras 252 may have any resolution. The one or more cameras 252 may include an omni-direction camera and/or a panoramic camera. In some aspects, one or more optical components, such as a mirror, fish-eye lens, or any other type of lens may be optically coupled to the one or more cameras 252. The image data collected by the one or more cameras 252 may be stored in the one or more memories 244.

Still referring to FIG. 2, a GPS unit 254 may be coupled to the communication path 230 and communicatively coupled to the computing device 240 of the apparatus 202. The GPS unit 254 is capable of generating location information indicative of a location of the apparatus 202 by receiving one or more GPS signals from one or more GPS satellites. The GPS signal communicated to the computing device 240 via the communication path 230 may include location information comprising a National Marine Electronics Association (NMEA) message, a latitude and longitude data set, a street address, a name of a known location based on a location database, or the like. Additionally, the GPS unit 254 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS unit 254 may be stored in the one or more memories 244.

The apparatus 202 may also include a radar system 256. The radar system 256 measures the distance to objects over wide distances. It is also possible to measure the relative speed of the detected object. The radar system 256 may be a continuous wave (CW), frequency-modulated continuous wave (FMCW), 3D-radar (such as 3D FMCW multiple-input and multiple-output (MIMO)), or 4D-radar (such as 4D FMCW MIMO). The sensor data collected by the radar system 256 may be stored in the one or more memories 244.

The apparatus 202 may include an inertial measurement unit (IMU) 258. The IMU 258 is an electronic device that measures and reports an apparatus's specific force, angular rate, and sometimes the orientation of the apparatus, using a combination of accelerometers, gyroscopes, and sometimes magnetometers. The sensor data collected by the IMU 258 may be stored in the one or more memories 244.

In some aspects, the apparatus 202 may include a LiDAR system 260. The LiDAR system 260 is communicatively coupled to the communication path 230 and the computing device 240. A LiDAR system 260 is a system and method of using pulsed laser light to measure distances from the LiDAR system 260 to objects that reflect the pulsed laser light. A LiDAR system 260 may be made as solid-state devices with few or no moving parts, including those configured as optical phased array devices where prism-like operation permits a wide field-of-view without the weight and size complexities associated with a traditional rotating LiDAR system 260. The LiDAR system 260 is particularly suited to measuring time-of-flight, which in turn can be correlated to distance measurements with objects that are within a field-of-view of the LiDAR system 260. By calculating the difference in return time of the various wavelengths of the pulsed laser light emitted by the LiDAR system 260, a digital 3-D representation of a target or environment may be generated. The pulsed laser light emitted by the LiDAR system 260 includes emissions operated in or near the infrared range of the electromagnetic spectrum, for example, having emitted radiation of about 905 nanometers. Sensors such as the LiDAR system 260 can be used by vehicles to provide detailed 3D spatial information for the identification of objects near the apparatus 202, as well as the use of such information in the service of systems for vehicular mapping, navigation and autonomous operations, especially when used in conjunction with geo-referencing devices such as GPS unit 254 or a gyroscope-based inertial navigation unit (INU, not shown or IMU 258) or related dead-reckoning system. The point cloud data collected by the LiDAR system 260 may be stored in the one or more memories 244.

Still referring to FIG. 2, apparatuses, such as vehicles, are now commonly equipped with communication systems, such as vehicle-to-vehicle communication systems. Some of the communication systems rely on network interface hardware 270. The network interface hardware 270 may be coupled to the communication path 230 and communicatively coupled to the computing device 240. The network interface hardware 270 may be any device capable of transmitting and/or receiving data with a network 280 or directly with another vehicle, such as a vehicle equipped with a vehicle-to-vehicle communication system. Accordingly, network interface hardware 270 can include a communication transceiver for sending and/or receiving any wired or wireless communication. For example, the network interface hardware 270 may include an antenna, a modem, LAN port, Wi-Fi card, WiMax card, mobile communications hardware, near-field communication hardware, satellite communication hardware and/or any wired or wireless hardware for communicating with other networks and/or devices. In some aspects, network interface hardware 270 includes hardware configured to operate in accordance with the Bluetooth wireless communication protocol. In some aspects, network interface hardware 270 may include a Bluetooth send/receive module for sending and receiving Bluetooth communications to/from a network 280 and/or another vehicle. In some aspects, the network interface hardware 270 may implement a radio access technology (RAT) such as a 5G or 6G RAT. For example, the network interface hardware 270 may provide vehicle-to-vehicle (V2V) connectivity, access network connectivity, sidelink connectivity (e.g., using a PC5 interface), or the like.

### Aspects Related to Adaptive Object Detection

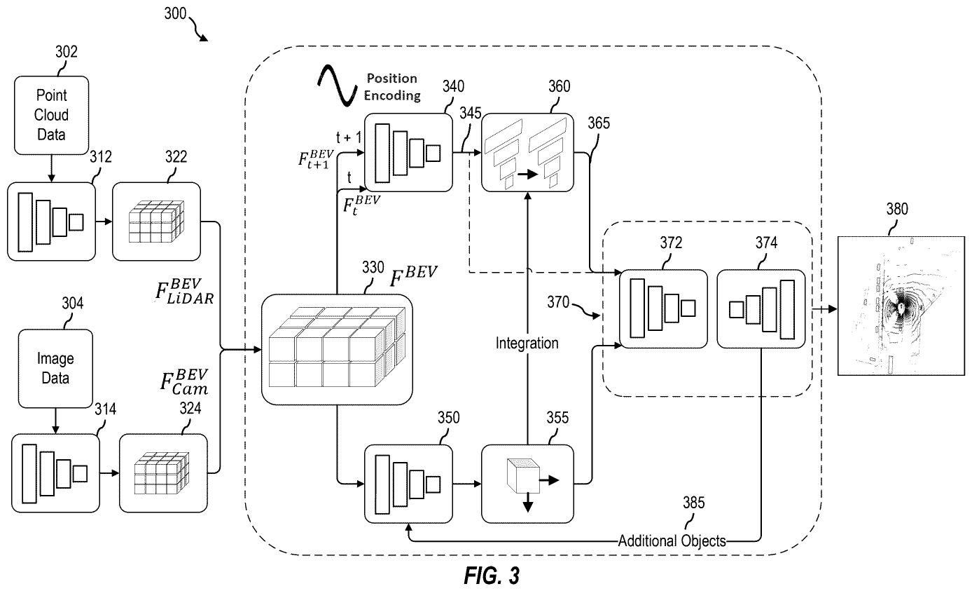

FIG. 3 depicts an illustrative block diagram of an architecture 300 for implementing adaptive object detection techniques. The architecture 300 may be implemented as software and/or hardware, such as the computing device 240 comprising one or more processors 242 and a non-transitory computer readable memory 244 shown for example in FIG. 2 (e.g., a processing system). The architecture 300 includes several components which will be described herein. The architecture 300 provides a unified pipeline that integrates scene flow estimation methods with object detection processes. The architecture 300 enables the system to capture both the spatial and dynamic characteristics of objects, even when object detection models are unable to detect and track objects that are not part of the training data.

In certain aspects, the unified pipeline integrates scene flow estimation methods with object detection processes to create a rich, multi-dimensional feature set that enhances the system's ability to detect both known and unknown dynamic objects. The enhancement of the system's ability to detect both known and unknown dynamic objects can provide downstream benefits to the functionality of autonomous systems such as the autonomous control of a vehicle, collision avoidance, or the like.

The architecture 300 ingests, over intervals of time, feature concatenations 330 for a scene. Feature concatenations 330 refer to 3D feature volumes that includes BEV features, for example, perceived by the one or more sensor modalities, such as cameras, LiDARs, RADAR, or the like, that are fused together and represented by the 3D feature volume. The feature concatenations 330 may include a first feature concatenation corresponding to a scene for a first timeframe and a second feature concatenation corresponding to the scene for a second timeframe. The feature concatenations 330 are formed from perception sensor data, such as point cloud data 302 and image data 304 that is obtained by corresponding sensors, such as LiDAR (e.g., the LiDAR system 260, FIG. 2) or RADAR (e.g., the radar system 256, FIG. 2) configured to generate point cloud data 302 and one or more cameras (e.g., the one or more cameras 252, FIG. 2) configured to generate the image data 304 over time for a scene of an environment.

For point cloud data 302, which may also be referred to herein as the first perception sensor data, may be voxelized. Voxelization of point cloud data includes discretizing continuous data into 3D space which is divided into cubes. Each of the cubes is assigned a center point according to the cube's neighboring points. A voxel is considered to be occupied when at least one point in the point cloud occupies the cube space defining the voxel. At block 312, the voxelized point cloud is fed through a 3D encoder backbone. The 3D encoder backbone is configured to extract features from the voxels to generate 3D features 322 (e.g., a 3D feature volume). The 3D encoder backbone may be an autoencoder, wavelet scattering model, a deep neural network, or the like. The 3D encoder backbone may be a bird's eye view (BEV) encoder that is configured to encode the point cloud data 302 into a BEV space. A BEV space for each timeframe may be generated as the corresponding sensors continue to feed the architecture with sensor data, such as point cloud data. The encoded BEV features may be referenced here by the following notation:

$${F}_{LiDAR}^{BEV} .$$

In a similar manner, the image data 304, which may also be referred to herein as the second perception sensor data, is obtained over time by the one or more cameras and encoded into a BEV feature space 324. The BEV feature space 324 may be generated at block 314 through the implementation of a BEV encoder, such as BEVFormer. BEVFormer may generate BEV features (e.g., BEV feature maps defining features and their corresponding location and/or dimensions) using spatiotemporal transformers. In certain aspects, block 314 may utilize a Lift-Splat approach, a deformable attention network (e.g., as implemented in BEVFormer), bilinear sampling, or other techniques to generate BEV feature space 324. The BEV features encoded in the BEV feature space 324 may be referenced here by the following notation:

$${F}_{C a m}^{B E V} .$$

The encoded features from the 3D features 322,

$${F}_{L i D A R}^{B E V} ,$$

and the BEV feature space 324,

$${F}_{C a m}^{B E V} ,$$

are combined to generate the feature concatenation 330, F^{BEV}. For example, the step of combining the 3D features 322,

$${F}_{L i D A R}^{B E V} ,$$

and the BEV feature space 324,

$${F}_{Cam}^{BEV} ,$$

to generate the feature concatenation 330, F^{BEV} at each timeframe for a time series of data may include a feature-fusion process, feature-wise concatenation, or a similar process. It should be understood that a feature concatenation 330, F^{BEV}, corresponding to a scene for each timeframe over a time series may be generated and fed into the architecture 300. For example, a first feature concatenation,

$${F}_{t}^{BEV} ,$$

corresponding to a scene for a first timeframe and a second feature concatenation,

$${F}_{t + 1}^{BEV} ,$$

corresponding to the scene for a second timeframe may be generated and fed into the architecture 300 over time.

The architecture 300 includes parallel paths for which the feature concatenation 330, F^{BEV}, at each timeframe are fed. A first path (illustrated toward the top of FIG. 3) includes a scene flow estimation process and a second path (illustrated toward the bottom of FIG. 3) includes an object detection process.

Along the first path, the first feature concatenation,

$${F}_{t}^{BEV} ,$$

the second feature concatenation,

$${F}_{t + 1}^{BEV} ,$$

and optionally subsequent feature concatenations may be fed into a transformer-based feature flow encoder 340. The transformer-based feature flow encoder 340 may be a BEV FeatureFlow Encoder. The transformer-based feature flow encoder 340 takes the consecutive timeframes of feature concatenations 330 (e.g., the first feature concatenation,

$${F}_{t}^{BEV} ,$$

the second feature concatenation,

$${F}_{t + 1}^{BEV} ) ,$$

optionally along with positional encodings for an apparatus, such as a vehicle, to extract motion features. For example, the transformer-based feature flow encoder 340 generates a scene flow for one or more features between the first feature concatenation and the second feature concatenation. The positional encodings (e.g., Pₜ,Pₜ₊₁) for the apparatus may include motion data, such as the apparatuses specific force, angular rate, and/or orientation obtained from a combination of IMU sensors such as accelerometers, gyroscopes, and/or magnetometers. The BEV features within the feature concatenations 330 encapsulate both spatial and visual information, while the pose data provides context for any changes in the vehicle's position and orientation.

In certain aspects, the transformer-based feature flow encoder 340 employs a multi-head self-attention mechanism to capture relationships between different parts of the input data (e.g., the feature concatenations 330 and the positional encodings). In a multi-head self-attention mechanism, a “Query,” a “Key,” and a “Value” are the three matrices that each of multiple heads uses to learn different patterns or focus on different aspects of the input. For example, the apparatus's pose change from t to t+1 may be given as a Query,

$${X}_{t} = [ {F}_{t}^{BEV} , {P}_{t} ]$$

may be given as Key, and

$${X}_{t + 1} = [ {F}_{t + 1}^{BEV} , {P}_{t + 1} ]$$

may be given as a Value. The self-attention mechanism computes the relevance of one part of the input with respect to another part of the input, while the multi-head attention captures the interactions between Key-Value pairs. It should be understood that the transformer-based feature flow encoder 340 implementing a multi-head self-attention mechanism is only one example implementation of the transformer-based feature flow encoder 340. One or more other models or techniques may be implemented as the transformer-based feature flow encoder 340 to achieve the processes described herein.

After processing the feature concatenations 330

$$( e . g . , {F}_{t}^{BEV} , {F}_{t + 1}^{BEV} )$$

and the positional encodings (e.g., Pₜ, Pₜ₊₁) through several layers of multi-head self-attention and feed-forward networks, the transformer-based feature flow encoder 340 produces a motion-aware feature representation at 345,

$${F}_{Motion}^{BEV} = {f}_{FlowEnc} ( {X}_{t} , {X}_{t + 1} ) .$$

Along the second path, which may be performed in parallel to the first path, an object encoder 350 may be used to generate initial 3D object proposals 355

$$( e . g . , {O}_{init}^{t} , {O}_{init}^{t + 1} )$$

from the fused BEV features with the feature concatenations 330. Initial 3D object proposals 355 refer to objects that the object encoder 350 identifies based on its one or more trained object detection models. As previously discussed, the object encoder 350 may be trained on datasets that define a limited set of object categories, referred to as a closed dataset. These closed datasets can create limitations to the performance of the object encoder 350. For example, the object encoder 350 may struggle to detect and track objects that are not part of the training data. The initial 3D object proposals 355 may not include every object represented in the feature concatenations 330 of the scene. However, the integration of the motion-aware feature representation produced in the first path at 345 allows for a more comprehensive analysis of both spatial and dynamic features of objects.

In some aspects, an object flow refiner 360 may receive the scene flow (e.g., the motion-aware feature representation) and the initial 3D object proposals 355 to refine the feature alignment of the one or more features between the first feature concatenation

$${F}_{t}^{BEV}$$

and the second feature concatenation

$${F}_{t + 1}^{BEV} ,$$

based on the one or more object proposals that classify the one or more groups of features as respective objects, to form a refined scene flow 365. The object flow refiner 360 is designed to enhance the feature alignment between consecutive frames from the transformer-based feature flow encoder 340.

The object flow refiner 360 can address the challenges posed by dynamic environments, particularly in refining object detection and tracking under conditions where objects boundaries may be complex to differentiate when alignment features differ from one frame to the other frame due to occlusion, crowding, or complex motion patterns. By taking the initial 3D object proposals 355 as a reference, the object flow refiner 360 seeks to align the features from consecutive frames, ensuring that the motion of each object is coherently tracked over time. Additionally, the object flow refiner 360 may iteratively adjust bounding boxes for the initial 3D object proposals 355 by comparing the aligned proposals with the observed features in the subsequent frame. This reduces (e.g., minimizes) the discrepancies between the predicted and actual positions of the objects thereby refining their boundaries to better match the visual and motion data. In some aspects, for example, the object flow refiner 360 may also employ a multi-head self-attention mechanism to guide the alignment of features between frames. The function of the object flow refiner 360 may be expressed by the following:

$${F}_{aligned}^{t + 1} = {f}_{align} ( {F}_{motion}^{BEV} , {O}_{init}^{t} , {O}_{init}^{t + 1} ) .$$

The first path and the second path of the architecture 300 converge at block 370. The refined scene flow 365, or the scene flow corresponding to the motion-aware feature representation 345, in instances where the object flow refiner 360 may not be implemented, from the first path and the initial 3D object proposals 355 from the second path are fed into block 370. At block 370, one or more encoder-decoder transformers (including, for example, an encoder 372 and a decoder 374) may be configured to fuse aligned motion cues based on the refined scene flow 365 (or the scene flow corresponding to the motion-aware feature representation 345) and initial object proposals 355 to identify and classify known and unknown dynamic and static objects within the scene. The one or more encoder-decoder transformers integrate the refined motion cues and initial object proposals into a unified representation. In aspects that include the object flow refiner 360, the refined scene flows 365 (e.g., the motion cues or vectors of features of the feature concatenations 330) help in identifying dynamic or moving objects between the scenes that may have been missed in the initial 3D object proposals 355.

An encoder 372 of the one or more encoder-decoder transformers may be configured to fuse the scene flow and the one or more object proposals (e.g., the initial 3D object proposals 355) into a representation of the scene. The encoder 372 processes the input scene flow features and initial 3D object proposals 355 to create context-aware representations. “Context-aware representations” refer to a way to represent contextual data in a form that may be both machine readable and human understandable. For example, context-aware representations may be the grouping of flow vectors for a set of features within the motion-aware feature representation, where the groupings may be further refined based on identification of particular features with the set of features as belonging to an object indicated by the initial 3D object proposals 355. In some aspects, the encoder 372 may use multiple layers of self-attention and feed-forward neural networks to capture intricate dependencies between features, such as related motion, dissimilar motion, related object identification, or dissimilar object identification. The self-attention mechanism may allow each feature to attend to all other features in the sequence of timeframes, thereby capturing both local and global relationships.

The decoder 374 of the one or more encoder-decoder transformers may be configured to receive the representation of the scene from the encoder 372 and identify a plurality of objects from the representation of the scene. The plurality of objects may include at least one object from the one or more object proposals and one or more additional objects. The one or more additional objects are objects that are not indicated by one of the initial 3D object proposals 355. The one or more additional objects may correspond to a second group of features that is separate from the one or more groups of features, for example, that are associated with respective ones of the one of the initial 3D object proposals 355. Additionally, the second group of features may include a common flow vector defined by the scene flow. “Common flow vector” refers to one or more vectors associated with features that have common attributes, such as direction, speed, or the like. The commonality of flow vectors (e.g., a set of common flow vectors) may indicate an object that was not identified by the object encoder 350. In some aspects, features of an object may be occluded such that the object encoder 350 cannot identify the object from the encoded features. The scene flow process may be able to identify groups of features that behave similarly together such that the group of features may be an object.

The decoder 374 is not limited to identifying objects merely through those which may have been included in training data. The decoder 374 is trained to identify objects through the combination of information with the representation of the scene which includes scene flow for features in the representation and indication of the initial 3D object proposals 355, which may be provided through bounding boxes that group features that the object encoder 350 considered to be an object.

The decoder 374 processes the fused features to produce the final object detection results. In some aspects, the decoder 374 may use a multi-head cross-attention to focus on both the scene flow and object proposals, which may be followed by a feed-forward network to generate the final bounding boxes and classifications.

For example, at block 380, a bounding box for each of the plurality of objects is generated, for example, by the feed-forward network. The bounding box includes location information, dimensional information, directional information, motion information, and/or other information. In some aspects, the bounding box may include a classification label for each of the objects. In certain aspects, at block 380, bounding boxes that may have been previously generated, for example, by the object encoder 350 or other trained model, may be refined by the feed-forward network so that the bounding box can be adjusted in dimension, location, direction, motion or the like. For example, the scene flow information may indicate that features associated with a first bounding box may be identified as corresponding to a different object. Thus, the bounding box's dimensions or other information may be adjusted so that features that are not associated with the object indicated by the bounding box can be excluded from the bounding box. The bounding box can manifest in multiple ways. The bounding box may be data encoded within a representation of the scene, such as a BEV of the scene. In some aspects, the bounding box may be graphically represented on a visual representation.

In certain aspects, the additional objects that are identified by the one or more encoder-decoder transformers may be provided (e.g., back-propagated) at 385 to the object encoder 350. The back-propagated data associated with the additional objects may be used to update one or more parameters of the object encoder 350. For example, the object encoder 350 can be retrained or iteratively trained so that the additional object information can cause the object encoder 350 learn to identify the additional object in future iterations.

In certain aspects, an apparatus or processing system may implement motion control of a vehicle based on the bird's eye representation of the scene comprising the respective bounding box for each of the plurality of objects (e.g., each object of the plurality may be associated with a different bounding box of a plurality of bounding boxes). In some aspects, the apparatus or processing system may implement collision avoidance control of a vehicle based on the bird's eye representation of the scene comprising the respective bounding box for each of the plurality of objects.

The architecture 300 and the associated processes described herein provides several advantages and enhancement to adaptive object detection techniques. For example, the architecture 300 provides more comprehensive analysis of both spatial and dynamic features of objects than implementation of either the first path or the second path alone. Additionally, systems can identify objects based on their movement patterns, making the architecture 300 particularly effective at detecting new or unexpected objects that were not part of the initial training data.

### Example Operations

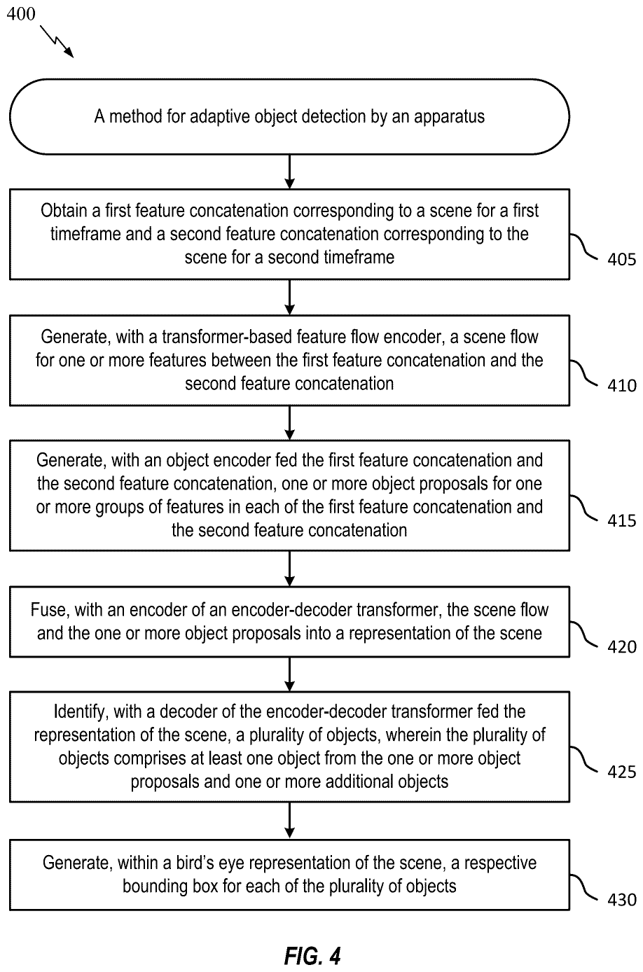

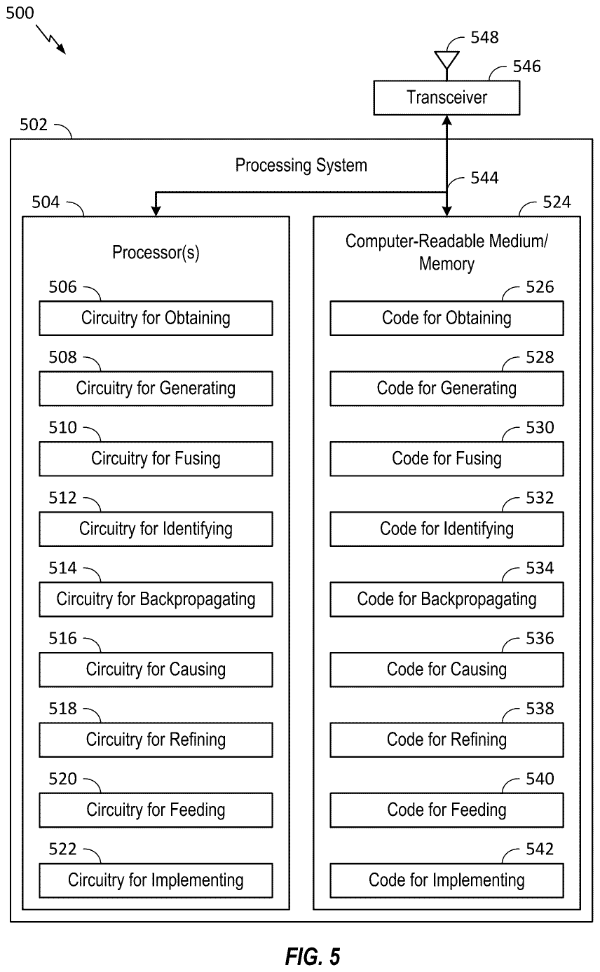

FIG. 4 shows an example method 400. Method 400 includes adaptive object detection techniques(s). Aspects of the method 400 can be implemented by the computing device 240 comprising one or more processors 242 and a non-transitory computer readable memory 244 shown for example in FIG. 2 and/or the apparatus 500 of FIG. 5.

Method 400 begins at block 405 with obtaining a first feature concatenation corresponding to a scene for a first timeframe and a second feature concatenation corresponding to the scene for a second timeframe. For example, block 405 may include obtaining feature concatenations 330, for example, the first feature concatenation corresponding to a scene for a first timeframe and a second feature concatenation corresponding to the scene for a second timeframe, the fusion of BEV 3D features 322 corresponding to point cloud data 302 and BEV feature space 324 corresponding to image data 304 as described with reference to the BEV representation portion 310 of FIG. 3.

Method 400 then proceeds to block 410 with generating, with a transformer-based feature flow encoder, a scene flow for one or more features between the first feature concatenation and the second feature concatenation. For example, block 410 may include aspects discussed with reference to the transformer-based feature flow encoder 340 as described with reference to FIG. 3.

Method 400 then proceeds to block 415 with generating, with an object encoder fed the first feature concatenation and the second feature concatenation, one or more object proposals for one or more groups of features in each of the first feature concatenation and the second feature concatenation. For example, block 415 may include aspects discussed with reference to the object encoder 350 as described with reference to FIG. 3.

Method 400 then proceeds to block 420 with fusing, with an encoder of an encoder-decoder transformer, the scene flow and the one or more object proposals into a representation of the scene. For example, block 420 may include aspects discussed with reference to the block 370 and the encoder 372 as described with reference to FIG. 3.

Method 400 then proceeds to block 425 with identifying, with a decoder of the encoder-decoder transformer fed the representation of the scene, a plurality of objects, wherein the plurality of objects comprises at least one object from the one or more object proposals and one or more additional objects. For example, block 425 may include aspects discussed with reference to the block 370 and the decoder 374 as described with reference to FIG. 3.

Method 400 then proceeds to block 430 with generating, within a bird's eye representation of the scene, a respective bounding box for each of the plurality of objects. For example, block 430 may include aspects discussed with reference to the block 370 and block 380 as described with reference to FIG. 3.

In some aspects, an additional object, of the one or more additional objects, corresponds to a second group of features that is separate from the one or more groups of features and wherein the second group of features comprises a common flow vector defined by the scene flow.

In some aspects, the respective bounding box for each of the plurality of objects comprises location information, dimensional information, directional information, and motion information.

In some aspects, each respective bounding box for one or more of the plurality of objects comprises a respective classification label.

In some aspects, method 400 further includes back-propagating the one or more additional objects to the object encoder.

In some aspects, method 400 further includes causing the object encoder to update one or more parameters based on the one or more additional objects.

In some aspects, method 400 further includes refining, with an object flow refiner fed the scene flow and the one or more object proposals, feature alignment of the one or more features between the first feature concatenation and the second feature concatenation, based on the one or more object proposals that classify the one or more groups of features as respective objects, to form a refined scene flow.

In some aspects, method 400 further includes feeding the refined scene flow to the encoder of the encoder-decoder transformer for fusion with the one or more object proposals into the representation of the scene.

In some aspects, method 400 further includes implementing motion control of a vehicle based on the bird's eye representation of the scene comprising the respective bounding box for each of the plurality of objects.

In some aspects, method 400 further includes implementing collision avoidance control of a vehicle based on the bird's eye representation of the scene comprising the respective bounding box for each of the plurality of objects.

In some aspects, method 400 further includes obtaining, from one or more sensors of the apparatus, first pose information of the apparatus at the first timeframe and second pose information of the apparatus at the second timeframe, and wherein the transformer-based feature flow encoder is further configured to generate the scene flow for features between the first feature concatenation and the second feature concatenation based on the first pose information and the second pose information.

In some aspects, the representation is a context-aware representation.

In some aspect, method 400, or any aspect related to it, may be performed by an apparatus, such as apparatus 500 of FIG. 5, which includes various components operable, configured, or adapted to perform the method 400. Apparatus 500 is described below in further detail.

Note that FIG. 4 is just one example of a method, and other methods including fewer, additional, or alternative operations are possible consistent with this disclosure.

### Example Apparatus

FIG. 5 depicts aspects of an example apparatus 500 configured for adaptive object detection techniques(s). In some aspects, apparatus 500 is may be the computing device 240 comprising one or more processors 242 and a non-transitory computer readable memory 244 shown for example in FIG. 2. In certain aspects, the apparatus 500 may be a vehicle or other device as discussed herein.

The apparatus 500 includes a processing system 505 coupled to a transceiver 585 (e.g., a transmitter and/or a receiver). The transceiver 585 is configured to transmit and receive signals for the apparatus 500 via an antenna 590, such as the various signals as described herein. The processing system 505 may be configured to perform processing functions for the apparatus 500, including processing signals received and/or to be transmitted by the apparatus 500.

The processing system 505 includes one or more processors 510 and a computer-readable medium/memory 545. In various aspects, the one or more processors 510 may be representative of the one or more processors of a computing device. The one or more processors 510 are coupled to a computer-readable medium/memory 545 via a bus 580. In some aspects, the computer-readable medium/memory 545 may be representative of the one or more memories (e.g., the non-transitory computer readable memory 244 described with respect to FIG. 2). The computer-readable medium/memory 545 is a non-transitory computer-readable medium/memory. In certain aspects, the computer-readable medium/memory 545 is configured to store instructions (e.g., computer-executable code), that when executed by the one or more processors 510, cause the one or more processors 510 to perform the method 400 described with respect to FIG. 4, or any aspect related to it, including any operations described in relation to FIG. 4. Note that reference to a processor performing a function of apparatus 500 may include one or more processors performing that function of apparatus 500, such as in a distributed fashion.

In the depicted example, computer-readable medium/memory 545 stores code (e.g., executable instructions), including code for obtaining 550, code for generating 555, code for fusing 560, code for identifying 565, code for capturing 570, and code for employing 575. Processing of the code 550-575 may enable and cause the apparatus 500 to perform the method 400 described with respect to FIG. 4, or any aspect related to it.

The one or more processors 510 include circuitry configured to implement (e.g., execute) the code stored in the computer-readable medium/memory 545, including circuitry for obtaining 515, circuitry for generating 520, circuitry for fusing 525, circuitry for identifying 530, circuitry for capturing 535, and circuitry for employing 540. Processing with circuitry 515-540 may enable and cause the apparatus 500 to perform the method 400 described with respect to FIG. 4, or any aspect related to it.

More generally, means for communicating, transmitting, sending or outputting for transmission may include the one or more transceivers 585, one or more antennas 590 of the apparatus 500 in FIG. 5, and/or one or more processors 510 of the apparatus 500 in FIG. 5. Means for communicating, receiving or obtaining may include the one or more transceivers 585, one or more antennas 590 of the apparatus 500 in FIG. 5, and/or one or more processors 510 of the apparatus 500 in FIG. 5.

### Example Clauses

Implementation examples are described in the following numbered clauses:
Clause 1: A method for adaptive object detection techniques by an apparatus comprising: obtaining a first feature concatenation corresponding to a scene for a first timeframe and a second feature concatenation corresponding to the scene for a second timeframe; generating, with a transformer-based feature flow encoder, a scene flow for one or more features between the first feature concatenation and the second feature concatenation; generating, with an object encoder fed the first feature concatenation and the second feature concatenation, one or more object proposals for one or more groups of features in each of the first feature concatenation and the second feature concatenation; fusing, with an encoder of an encoder-decoder transformer, the scene flow and the one or more object proposals into a representation of the scene; identifying, with a decoder of the encoder-decoder transformer fed the representation of the scene, a plurality of objects, wherein the plurality of objects comprises at least one object from the one or more object proposals and one or more additional objects; and generating, within a bird's eye representation of the scene, a respective bounding box for each of the plurality of objects.
Clause 2: The method of Clause 1, wherein an additional object, of the one or more additional objects, corresponds to a second group of features that is separate from the one or more groups of features and wherein the second group of features comprises a common flow vector defined by the scene flow.
Clause 3: The method of any one of Clauses 1-2, wherein the respective bounding box for each of the plurality of objects comprises location information, dimensional information, directional information, and motion information.
Clause 4: The method of Clause 3, wherein each respective bounding box for one or more of the plurality of objects comprises a respective classification label.
Clause 5: The method of any one of Clauses 1-4, further comprising: back-propagating the one or more additional objects to the object encoder; and causing the object encoder to update one or more parameters based on the one or more additional objects.
Clause 6: The method of any one of Clauses 1-5, further comprising: refining, with an object flow refiner fed the scene flow and the one or more object proposals, feature alignment of the one or more features between the first feature concatenation and the second feature concatenation, based on the one or more object proposals that classify the one or more groups of features as respective objects, to form a refined scene flow; and feeding the refined scene flow to the encoder of the encoder-decoder transformer for fusion with the one or more object proposals into the representation of the scene.
Clause 7: The method of any one of Clauses 1-6, further comprising implementing motion control of a vehicle based on the bird's eye representation of the scene comprising the respective bounding box for each of the plurality of objects.
Clause 8: The method of any one of Clauses 1-7, further comprising implementing collision avoidance control of a vehicle based on the bird's eye representation of the scene comprising the respective bounding box for each of the plurality of objects.
Clause 9: The method of any one of Clauses 1-8, further comprising: obtaining, from one or more sensors of the apparatus, first pose information of the apparatus at the first timeframe and second pose information of the apparatus at the second timeframe, and wherein the transformer-based feature flow encoder is further configured to generate the scene flow for features between the first feature concatenation and the second feature concatenation based on the first pose information and the second pose information.
Clause 10: The method of any one of Clauses 1-9, wherein the representation is a context-aware representation.
Clause 11: One or more apparatuses, comprising: one or more memories comprising executable instructions; and one or more processors configured to execute the executable instructions and cause the one or more apparatuses to perform a method in accordance with any one of Clauses 1-10.
Clause 12: One or more apparatuses configured for adaptive object detection, comprising: one or more memories; and one or more processors, coupled to the one or more memories, configured to cause the one or more apparatuses to perform a method in accordance with any one of Clauses 1-10.
Clause 13: One or more apparatuses configured for adaptive object detection, comprising: one or more memories; and one or more processors, coupled to the one or more memories, configured to perform a method in accordance with any one of Clauses 1-10.
Clause 14: One or more apparatuses, comprising means for performing a method in accordance with any one of Clauses 1-10.
Clause 15: One or more non-transitory computer-readable media comprising executable instructions that, when executed by one or more processors of one or more apparatuses, cause the one or more apparatuses to perform a method in accordance with any one of Clauses 1-10.
Clause 16: One or more computer program products embodied on one or more computer-readable storage media comprising code for performing a method in accordance with any one of Clauses 1-10.
Clause 17: One or more apparatuses configured for adaptive object detection, comprising: a processing system that includes one or more processors and one or more memories coupled with the one or more processors, the processing system configured to cause the one or more apparatuses to perform a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising: a processing system that includes one or more processors and one or more memories coupled with the one or more processors, the processing system configured to cause the apparatus to:
obtain a first feature concatenation corresponding to a scene for a first timeframe and a second feature concatenation corresponding to the scene for a second timeframe;
generate, with a transformer-based feature flow encoder, a scene flow for one or more features between the first feature concatenation and the second feature concatenation;
generate, with an object encoder fed the first feature concatenation and the second feature concatenation, one or more object proposals for one or more groups of features in each of the first feature concatenation and the second feature concatenation;
fuse, with an encoder of an encoder-decoder transformer, the scene flow and the one or more object proposals into a representation of the scene;
identify, with a decoder of the encoder-decoder transformer fed the representation of the scene, a plurality of objects, wherein the plurality of objects comprises at least one object from the one or more object proposals and one or more additional objects; and
generate, within a bird's eye representation of the scene, a respective bounding box for each of the plurality of objects.

2. The apparatus of claim 1, wherein an additional object, of the one or more additional objects, corresponds to a second group of features that is separate from the one or more groups of features and wherein the second group of features comprises a common flow vector defined by the scene flow.

3. The apparatus of claim 1, wherein the respective bounding box for each of the plurality of objects comprises location information, dimensional information, directional information, and motion information.

4. The apparatus of claim 3, wherein each respective bounding box for one or more of the plurality of objects comprises a respective classification label.

5. The apparatus of claim 1, wherein the processing system is configured to cause the apparatus to:
back-propagate the one or more additional objects to the object encoder; and
cause the object encoder to update one or more parameters based on the one or more additional objects.

6. The apparatus of claim 1, wherein the processing system is configured to cause the apparatus to:
refine, with an object flow refiner fed the scene flow and the one or more object proposals, feature alignment of the one or more features between the first feature concatenation and the second feature concatenation, based on the one or more object proposals that classify the one or more groups of features as respective objects, to form a refined scene flow; and
feed the refined scene flow to the encoder of the encoder-decoder transformer for fusion with the one or more object proposals into the representation of the scene.

7. The apparatus of claim 1, wherein the processing system is configured to cause the apparatus to implement motion control of a vehicle based on the bird's eye representation of the scene comprising the respective bounding box for each of the plurality of objects.

8. The apparatus of claim 1, wherein the processing system is configured to cause the apparatus to implement collision avoidance control of a vehicle based on the bird's eye representation of the scene comprising the respective bounding box for each of the plurality of objects.

9. The apparatus of claim 1, wherein the processing system is configured to cause the apparatus to:
obtain, from one or more sensors of the apparatus, first pose information of the apparatus at the first timeframe and second pose information of the apparatus at the second timeframe, and
wherein the transformer-based feature flow encoder is further configured to generate the scene flow for features between the first feature concatenation and the second feature concatenation based on the first pose information and the second pose information.

10. The apparatus of claim 1, wherein the representation is a context-aware representation.

11. A method for adaptive object detection by an apparatus comprising:
obtaining a first feature concatenation corresponding to a scene for a first timeframe and a second feature concatenation corresponding to the scene for a second timeframe;
generating, with a transformer-based feature flow encoder, a scene flow for one or more features between the first feature concatenation and the second feature concatenation;
generating, with an object encoder fed the first feature concatenation and the second feature concatenation, one or more object proposals for one or more groups of features in each of the first feature concatenation and the second feature concatenation;
fusing, with an encoder of an encoder-decoder transformer, the scene flow and the one or more object proposals into a representation of the scene;
identifying, with a decoder of the encoder-decoder transformer fed the representation of the scene, a plurality of objects, wherein the plurality of objects comprises at least one object from the one or more object proposals and one or more additional objects; and
generating, within a bird's eye representation of the scene, a respective bounding box for each of the plurality of objects.

12. The method of claim 11, wherein an additional object, of the one or more additional objects, corresponds to a second group of features that is separate from the one or more groups of features and wherein the second group of features comprises a common flow vector defined by the scene flow.

13. The method of claim 11, wherein the respective bounding box for each of the plurality of objects comprises location information, dimensional information, directional information, and motion information.

14. The method of claim 13, wherein each respective bounding box for one or more of the plurality of objects comprises a respective classification label.

15. The method of claim 11, further comprising:
back-propagating the one or more additional objects to the object encoder; and
causing the object encoder to update one or more parameters based on the one or more additional objects.

16. The method of claim 11, further comprising:
refining, with an object flow refiner fed the scene flow and the one or more object proposals, feature alignment of the one or more features between the first feature concatenation and the second feature concatenation, based on the one or more object proposals that classify the one or more groups of features as respective objects, to form a refined scene flow; and
feeding the refined scene flow to the encoder of the encoder-decoder transformer for fusion with the one or more object proposals into the representation of the scene.

17. The method of claim 11, further comprising implementing motion control of a vehicle based on the bird's eye representation of the scene comprising the respective bounding box for each of the plurality of objects.

18. The method of claim 11, further comprising implementing collision avoidance control of a vehicle based on the bird's eye representation of the scene comprising the respective bounding box for each of the plurality of objects.

19. The method of claim 11, further comprising:
obtaining, from one or more sensors of the apparatus, first pose information of the apparatus at the first timeframe and second pose information of the apparatus at the second timeframe, and
wherein the transformer-based feature flow encoder is further configured to generate the scene flow for features between the first feature concatenation and the second feature concatenation based on the first pose information and the second pose information.

20. A system comprising:
one or more cameras configured to generate image data of a scene;
one or more additional sensors configured to generate point cloud data of the scene; and
a processing system that includes one or more processors and one or more memories coupled with the one or more processors, the processing system configured to cause the system to:
obtain, based on the image data and the point cloud data of the scene, a first feature concatenation corresponding to the scene for a first timeframe and a second feature concatenation corresponding to the scene for a second timeframe;
generate, with a transformer-based feature flow encoder, a scene flow for one or more features between the first feature concatenation and the second feature concatenation;
generate, with an object encoder fed the first feature concatenation and the second feature concatenation, one or more object proposals for one or more groups of features in each of the first feature concatenation and the second feature concatenation;
fuse, with an encoder of an encoder-decoder transformer, the scene flow and the one or more object proposals into a representation of the scene;
identify, with a decoder of the encoder-decoder transformer fed the representation of the scene, a plurality of objects, wherein the plurality of objects comprises at least one object from the one or more object proposals and one or more additional objects; and
generate, within a bird's eye representation of the scene, a respective bounding box for each of the plurality of objects.
